(19) United States
(12) Patent Application Publication
(10) Pub. No.: US 2007/0210147 A1
(43) Pub. Date: Sep. 13, 2007

(54) Pocket-size talking card or pamphlet device and packages containing the same

(76) Inventors: Jack Morrone, Coco Beach, FL (US); Fred Pether, St. Petersburg, FL (US); Matthew T. Coe, Annandale, NJ (US); Richard Costa, Bedminster, NJ (US)

Correspondence Address: Allen R. Kipnes, Esq.;WATOV & KIPNES, P.C., P.O. Box 247, Princeton Junction, NJ, 08550, US

(21) Appl. No.: 11/371,817

(22) Filed: Mar. 9, 2006

(51) Int. Cl. G06F 17/00; G06K 15/00

(52) U.S. Cl. 235/375; 235/383

(57) ABSTRACT

A talking card device includes a support member comprising a printed portion viewable by the consumer, an electronic storage element operatively engaged to the support member, wherein the electronic storage element is adapted to store an audio communication relating to the article of manufacture in an electronic form, and an audio assembly component electronically connected to the storage element, and configured to receive the electronic form of the audio communication upon actuation of a consumer operable switch, wherein electronic form of the audio communication is converted into an audio form for the consumer to hear. The printed information and audio communication may be coordinated to provide comprehensive information to the consumer about the article of manufacturer.

### FIELD OF THE INVENTION

The present invention is relates to informational devices, and more particularly an information conveying device in the form of a pocket-sized talking card device, designed to accompany articles of manufacture such as, for example, pharmaceutical products including medications, and medical devices, which convey to consumers product-related information corresponding to the article of manufacture, and to a package which includes the pocket-size talking card device and the article of manufacture.

### BACKGROUND OF THE INVENTION

An estimated 70% of all medical prescriptions go unused, resulting in $77 billion in excess healthcare costs each year. The cause for noncompliance is frequently related to a failure in communication. Often patients may not appreciate the importance of complying with medical prescriptions, or doctors or pharmacists may have failed to explain the treatment regimen, product efficacy, or even adverse drug side effects to their patients. It is estimated that 40% of patients who receive outpatient drug therapy will encounter a treatment failure or a new medical problem as a result of noncompliance with the prescribed treatment regimen. Noncompliance has been implicated in 125,000 deaths and up to 20% of all hospital and nursing home admissions a year. Patient anxiety about medications and medical treatments has also been found to contribute to the patient noncompliance. Increasing accessibility of information to patient that is easy to understand, may alleviate much of the anxiety, and improve compliance.

During the course of medical treatment, a physician is expected to furnish vital medical advice and information to meet the educational and information needs of the patient. Such medical information is generally related to treatment, procedure, medication, and/or medical devices. This medical information is critical for promoting patient compliance and awareness and ensuring informed decision-making and is typically communicated to the patient by the attending physician during a medical exam or by a pharmacist, typically when filling the patient's prescription.

Physicians need to provide their patients with details of a medical treatment and instructions on how to administer prescriptions such as the frequency of ingestion and specific time intervals (e.g. once a day or after every meal). Such intervals may range from a matter of hours to a day or more, depending on the medication and the condition being treated. In a pharmacy setting where a prescription is filled, the pharmacist is expected to provide necessary medical information concerning the prescription medication or medical device dispensed to the patient. However, due to mounting time constraints and growing patient load, physicians and pharmacists are becoming increasingly limited in their ability to convey all the pertinent information to the patient needed to ensure compliance. Questions that patients may have or those that arise at a later time often go inadvertently unanswered or overlooked.

With prescription and over-the-counter medications, packaging and leaflets are printed with necessary drug information such as administration instructions and dosing, symptoms and conditions to be treated, warnings, ingredients, and the like to enable patients to comply with the treatment regimen and to avoid the potential dangers of noncompliance. The drug information accompanying such medications, adds another means of ensuring patient compliance. The information informs the patient about the particulars of the corresponding medical treatment and/or drug regimen. Patient compliance information may also be provided with medical devices such as wheelchairs, walkers, prosthetic devices, hearing aids and even eyeglasses.

There has been growing interest in providing patients with even greater access to information about medical treatments and medications and medical devices beyond the typical interactions between physician and patient. In 1995, the Food and Drug Administration (FDA) proposed a rule requiring the distribution of scientifically accurate and useful written information with all new and refill prescriptions, including information about adverse effects, black box warnings and guidance on how to best use the drugs. The FDA had set a goal that by the year 2000, 75 percent of patients would be receiving patient information leaflets, and by the year 2006, 95 percent of patients receive this information. In 1996 Congress enacted a law adopting the FDA goals and timetable, and mandating the private sector to design and implement the program.

There are limitations or problems associated with such packaging and leaflet information. The large amount of information and often reduced font size of the printed information typically provides little incentive to the patient to read the material. The information often goes unnoticed because most patients are not inclined to read the information that is usually hard to understand or too time consuming to read. Patients with impaired vision are deterred from reading the material. Moreover, if the information is printed in a language that the patient is not fluent, the possibility of patient noncompliance is significantly increased. These and other factors can greatly diminish a patient's ability to comprehend and understand the instructions and warnings necessary to comply with a prescribed treatment regimen, to the detriment of the patient.

Accordingly, there is a need, for a pocket-size card or pamphlet device capable of providing audio communication to the patient (referred to herein as a pocket sized talking card or pamphlet device). The device should be designed to communicate product-related information to a consumer in association directly or indirectly with an article of manufacture such as, for example, a pharmaceutical product, a medication, or a medical device prescribed to a patient. Such a talking card or pamphlet device would be especially useful for consumers with disabilities such as limited sight, limited literacy, and those with limited language fluency. The device may be packaged and/or distributed along with the associated article of manufacture so that product information is readily available when needed. It would be a further advantage in the art if the talking card or pamphlet device had a compact and lightweight profile for convenient use in a package as a packaging insert for articles of manufacture.

### SUMMARY OF THE INVENTION

The present invention relates generally to a pocket-size talking card or pamphlet device designed to convey important product-related information to a consumer through the use of a touch-activated interface. The talking card or pamphlet device of the present invention provides a simple informational tool to educate consumers about a corresponding article of manufacture including medical products such as, for example, medications, medical devices, and the like, and to enhance patient compliance with such products. The device of the present invention is intended for distribution alone or in conjunction with the article of manufacture such as in a package, and for providing information to answer most, if not all, of the questions the consumer may have about the corresponding article of manufacture.

The device of the present invention has a compact profile for convenient packaging and which enables the consumer to carry the device. In this manner, the talking card or pamphlet device of the present invention facilitates access to useful and coordinated prerecorded audio and optional visual information concerning an article of manufacture, including, for example, instructions on proper usage of the corresponding article of manufacture.

The talking card or pamphlet device of the present invention is particularly suited for use by consumers with disabilities such as limited sight, limited literacy, and limited language fluency. The talking card or pamphlet device may be conveniently dispensed or distributed, for example, in a physician- or a pharmacy-patient setting along with the article of manufacture such as a medical product. Thus, the device of the present invention can also be used to provide the patient with information relevant to the proper use and handling of the medical product in an effective and cost-efficient manner, and is thus especially suitable for use in the pharmaceutical and medical industries. The device may also be used in conjunction with medical device supply outlets when patients purchase medical devices.

Generally, the talking card or pamphlet device of the present invention comprises a support member with a printed portion viewable by the consumer (e.g., patient), an electronic storage element operatively engaged to the support member, wherein the electronic storage element is adapted to store information in an electronic form; and an audio assembly component electronically connected to the storage element, and configured to receive the electronic form of the information upon actuation by a consumer, and to convert the electronic form of the information into an audio form for the user to hear. The printed portion and audio communication are coordinated to provide comprehensive instructions in a consumer friendly format regarding use of the article of manufacture.

In one aspect of the present invention, there is provided a pocket-sized talking card device accompanying an article of manufacture, comprising:

a support member comprising a printed portion viewable by a consumer;

an electronic storage element operatively engaged to the support member, said electronic storage element adapted to store information relating to the article of manufacture in an electronic form;

an audio assembly component electronically connected to the storage element, and configured to receive the electronic form of the information, and to convert the electronic form of the information into an audio communication upon actuation by the consumer; and

means for activating the audio communication by the consumer.

In a further aspect of the present invention, the audio and visual communications of the present invention are coordinated to provide comprehensive information about the article of manufacture.

In another aspect of the present invention, there is provided a packaging insert for an article of manufacture, comprising:

a support member comprising a printed portion containing printed information pertaining to the article of manufacturer viewable by a consumer;

an electronic storage element operatively engaged to the support member, said electronic storage element adapted to store information relating to the article of manufacture in an electronic form for subsequent processing into an audio communication by an audio assembly component;

the audio assembly component electronically connected to the storage element on a permanent or reversible bases, and configured to receive the electronic form of the information, and to convert the electronic form of the information into the audio communication upon actuation by the consumer; and

means for activating the audio communication by the consumer.

In a further aspect of the invention there is provided a package comprising the pocket-size talking device and the article of manufacture.

In a still further aspect of the present invention, there is provided a method of informing the consumer about an article of manufacture, comprising providing the consumer with an article of manufacture, and a talking-card device associated with the article of manufacture, wherein the talking card device comprises a support member comprising a printed portion viewable by the consumer, an electronic storage element operatively engaged to the support member, the electronic storage element adapted to store information in an electronic form; and an audio assembly component electronically connected to the storage element, and configured to receive the electronic form of the information, and to convert the electronic form of the information into an audio communication upon actuation by the consumer, wherein the audio and visual communications are coordinated to provide comprehensive information about the article of manufacture.

In another aspect of the present invention, there is provided a method for enhancing compliance in the proper use of an article of manufacture, the method comprising:

identifying the article of manufacture for distribution to the user;

furnishing to the user a talking card device of the present invention, containing information related to the article of manufacture and pertinent to promoting compliance in the proper use of the article of manufacture; and

conveying to the user from the talking card device the information through audio and visual forms of communication.

### BRIEF DESCRIPTION OF THE DRAWINGS

The following drawings in which like reference characters indicate like parts are illustrative of embodiments of the invention and are not intended to limit the invention as encompassed by the claims forming part of the application.

FIG. 1 is a front perspective view of a pocket-size talking card or pamphlet device for one embodiment of the present invention;

FIG. 2 is a rear perspective view of the talking card or pamphlet device in accordance with the present invention;

FIG. 3 is a perspective view of the talking card or pamphlet device with the printed portion pulled out into an extended position in accordance with the present invention;

FIG. 4 is a circuit diagram of the talking card or pamphlet device detailing the arrangement of the electrical components in accordance with the present invention;

FIG. 5 is a package containing the pocket-size talking card or pamphlet device shown in FIG. 1 with an article of manufacture in the form of a pill container; and

FIG. 6 is a perspective view of a pocket-size talking card or pamphlet device for a second embodiment of the present invention;

FIG. 7 is a perspective view of the talking card or pamphlet device shown in FIG. 6 with a pull-out card in the extended position in accordance with the present invention;

FIG. 8 is a perspective view of a bottom portion of the talking card or pamphlet device of FIG. 6 in accordance with the present invention;

FIG. 9 is an exploded assembly view of the talking card or pamphlet device shown in FIG. 6 in accordance with the present invention;.

### DETAILED DESCRIPTION OF THE INVENTION

The present invention is directed to a pocket-size talking card or pamphlet device designed as a hand-holdable information conveying tool for consumers. The talking card or pamphlet device of the present invention is designed to inform consumers about a product referred herein as an article of manufacture including medical prescriptions and medical devices in order to facilitate consumer compliance with all aspects of the article of manufacture, such as patient compliance when the article of manufacture is a medication.

In one application, the talking card or pamphlet device is part of a package which includes an article of manufacture. The talking card or pamphlet device provides information and details specific to the related article of manufacture. In a more particular application, the present invention is distributed along with a medical product such as medications or medical devices to patients. The device of the present invention provides visual information and provides an audio communication (audio playback operation) upon activation by the consumer to provide the information to the consumer. The visual and audio information may be coordinated to provide comprehensive information regarding the related article of manufacture.

The audio playback operature relays audio information to the consumer relating to the accompanying article of manufacture or product. In this manner, the consumer is able to receive coordinated information about the article of manufacture by audio and visual means. The information may be provided in at least one language, which the consumer may select. In this manner, the device of the present invention enables consumers with limited sight, those with limited literacy, and those with limited language fluency to gather and obtain information about the related article of manufacture in a more effective and meaningful manner.

The device of the present invention is intended to assist consumer compliance and thereby prevent harmful effects from improper usage of a product by informing consumers on the proper use of the article of manufacture, particularly, medical products. For example, the device may be designed to provide pharmaceutical or drug information prescribed to the consumer wherein the article of manufacture is a medication.

Product related information such as those supplied in the form of brochures, inserts or pamphlets are often difficult for the consumer to read especially those consumers with no more than limited vision including those having difficulty reading fine print material, or those with limited language proficiency or literacy skills. With medical products, traditional pamphlets disseminate useful information and details of medications and medical devices, however, the information is typically in a form that is difficult to read or comprehend. This adversely affects the consumer's retention and appreciation of the information regarding the prescribed medication or medical device and may even be ignored by the consumer. As a result, the consumer may take the medications improperly or use the medical device incorrectly to their detriment.

The device of the present invention is inexpensive to construct and implement, and is especially suitable for consumers including the elderly and those with no more than limited vision including those having difficulty reading fine print material (i.e., medical information leaflet or pamphlet), or those with limited language proficiency or literacy skills.

The talking card or pamphlet device of the present invention will be described generally in the context of packaging and distribution with medical products such as medications, medical devices, and the like, and for enhancing patient compliance and facilitating proper usage, dosing, and treatment of such products. As used herein, the term “medical product” shall refer to any product useful to treat, diagnose or prevent a medical disease, symptom or condition thereof. It will, however, be understood that the device of the present invention can be applied to any article of manufacture where the consumer will benefit from the furnishing of information and details about the article of manufacture through a coordinated visual and audio means.

It has been observed through numerous physician/patient interactions that patients who are aware of basic medically relevant information concerning a product (e.g., a medication or a medical device) tend to be twice as compliant as compared to those that lack or ignore the same information. To enhance compliance, such basic medically relevant information must be provided in terms that are easy for a layperson to understand, and at least include one or more of the following: 1) details about the product including manner of action; 2) details about proper practice including mode of administration, dosing or usage intervals, and the like; 3) details about duration of usage including the length of the prescribed treatment; 4) details about adverse side effects or contraindications; and 5) details about the consequences of terminating use of the product before the full length of the prescribed treatment.

As used herein, the term “basic medically relevant information” is intended to encompass information relevant to a medical product including, but not limited to, manner of action, proper practice, duration of usage, adverse side effects or risks, consequences of improper usage including premature termination of usage, and combinations thereof.

Accordingly, the device of the present invention may be utilized to provide the consumer with the basic relevant information with respect to the article of manufacture. In one scenario, the device of the present invention may be used for providing the basic medically relevant information concerning medical products such as medical devices and pharmaceutical products. The present invention, however, is not intended to be a substitute for or replace actual consultation with medical personnel including doctors, medical supply specialists and pharmacists. Instead the present invention is to be used as a tool or aid to assist the medical profession and particularly medical personnel in providing sufficient disclosure of the basic medically relevant information to the consumer. After using the device of the present invention, the patient may discuss any questions or issues that the patient may have with the attending medical personnel as needed.

The talking card or pamphlet device of the present invention has been designed to coordinate information expressed through visual and audio means to enhance comprehension and retention of information conveyed about an article of manufacture such as medical products. As used herein the “coordination of visual and audio information” or related term shall mean that the visual and audio means of the present device both provide information related to the article of manufacture. The information may be duplicative, complimentary, sequential or the like, so long as the coordination of both forms of information provides a benefit beyond that obtained from the use of audio or visual information alone. By way of example, the audio means may describe in words the dosage regimen required for a particular medication while the visual means provides the same information in printed form. In the context of medication and treatment compliance, the talking card and pamphlet device of the present invention further enhances the ease and regularity of administration by encouraging the patient to use the information and improving the patient's ability to remember important information. In addition, the small size and compact profile of the device makes it especially convenient for carry and portable operation.

In one embodiment, the information contained in the talking card or pamphlet device may include, but is not limited to, drug information, details about affected body parts or organ systems, administration instructions and dosing, symptoms and conditions to be treated, warnings, ingredients, instructions for operating the medical product, and the like.

Generally, there is provided a talking card or pamphlet device for relaying product information to consumers about the article of manufacture packaged therewith. The talking card or pamphlet device includes a support member comprising a printed portion viewable by the consumer containing useful information about the medical product, an electronic storage element operatively engaged to the support member, the electronic storage element adapted to store information relating to the article of manufacture in an electronic form; and an audio assembly component electronically connected to the storage element through permanent or reversible means, and configured to receive the electronic form of the information, and to convert the electronic form of the information into an audio communication upon actuation by the consumer.

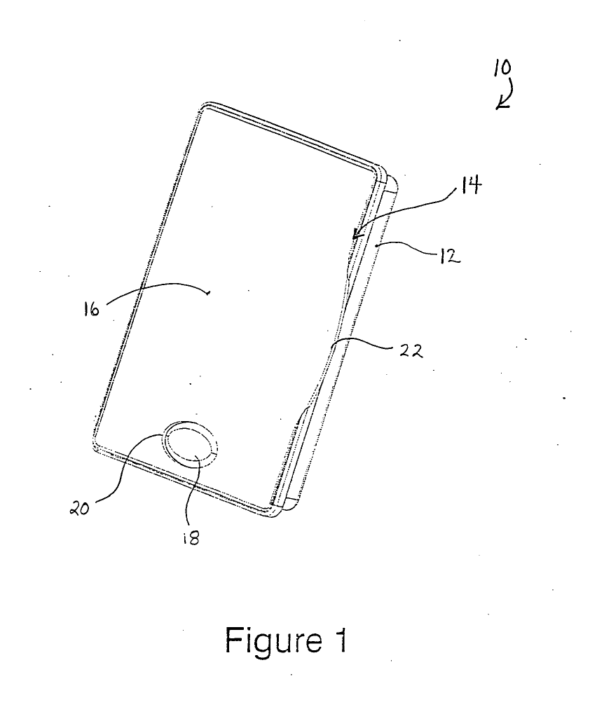

Referring to FIG. 1, a pocket talking card or pamphlet device identified generally by reference numeral 10 is shown for one embodiment of the present invention. The talking card or pamphlet device 10 may be distributed to a consumer (e.g., patient) in association with an article of manufacture such as, for example, a medical product including, but not limited to, a medical device, a pharmaceutical product, and the like. Alternatively, the device 10 can be in the form of a packaging insert wherein the packaging insert and article of manufacture are packaged together. The device can contain, for example, instructions and details on usage and contraindications.

The talking card or pamphlet device 10 is designed to promote effective interaction by the consumer with the content of the display in association with the article of manufacture. The talking card or pamphlet device 10 may be constructed from any durable material such as plastic, and molded into any size, shape, or color for easy identification and association with a specific type of article of manufacture, such as a medical product.

In one setting, the talking card or pamphlet 10 is designed to assist elderly users, blind or nearly blind users, users with limited literacy skills, and/or users with limited language fluency, who may experience difficulties reading information typically accompanying prescription or over the counter medications or medical devices. The device 10 is further designed to convey information in a manner to enhance patient compliance in order to reduce injury and possible deaths, and minimize ineffective treatments through improper or incomplete use. For those not fluent in a specific language, the information may be conveyed in a language the user understands.

The talking card or pamphlet device 10 comprises a case portion 12 shown in this embodiment having a substantially flat rectilinear profile, and a support member 14 with a printed surface portion 16, which contains information relevant to the article of manufacture. The device 10 further comprises an activation button 18 extending through an aperture 20 in the support member 14. The activation button 18 is depressed to activate the audio portion of the device 10 to provide an audio communication to the consumer. It will be understood that the talking card or pamphlet device of the present invention may be modified to include multiple activation buttons (e.g., five buttons), each for playing back a different audio communication, the number of activation buttons 18 employed will typically depend on the arrangement, context and content of the printed and recorded information.

The usual information provided by the printed surface portion and the information contained in the audio communication are coordinated to provide a comprehensive teaching about the article of manufacture to enable the consumer to properly employ the same including basic medically relevant information for medical products. The coordination of the visual and audio means may be accomplished by providing instructions by audio with a graphic visual display.

The device 10 is a small and compact and therefore suitable for packaging with small articles of manufacture such as pills contained within a pill container, and the like. The support member 14 may be configured for pull-out operation as will be described hereinafter. The support member 14 may include a tab portion 22 by which the consumer may move and view the support member 14 at a different position or expand to provide a greater viewing area.

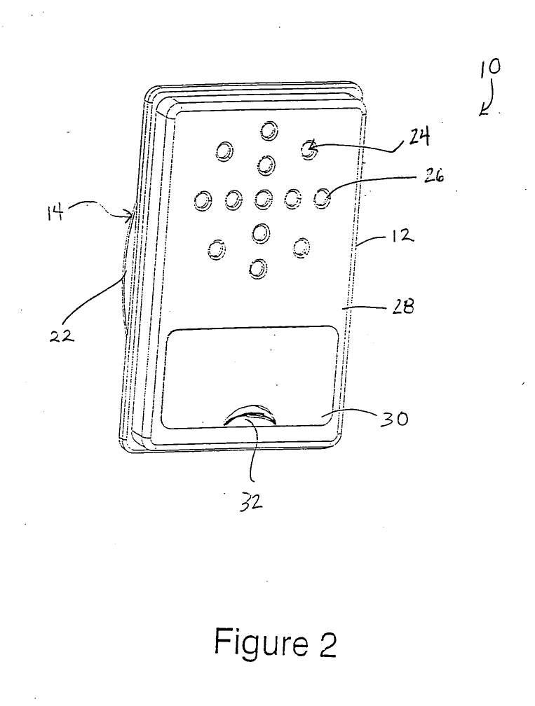

Referring to FIG. 2, the talking card or pamphlet device 10 further includes an audio output or speaker device 24 located inside the case portion 12 on the rearward side 28 of the device 10. A plurality of openings 26 are provided in the case portion 12 to facilitate the transmission of sound from the speaker device 24 enclosed therein. The talking card or pamphlet device 10 may further include a card receiving area (not shown) with a reversible enclosure 30. The card receiving area (not shown) can be adapted to accommodate a plurality of business cards for placement in a stacked arrangement for storage. The consumer may open the enclosure 30 through a tab portion 32 to add or remove the cards. The reversible enclosure 30 may be transparent through which the consumer can view the retained cards.

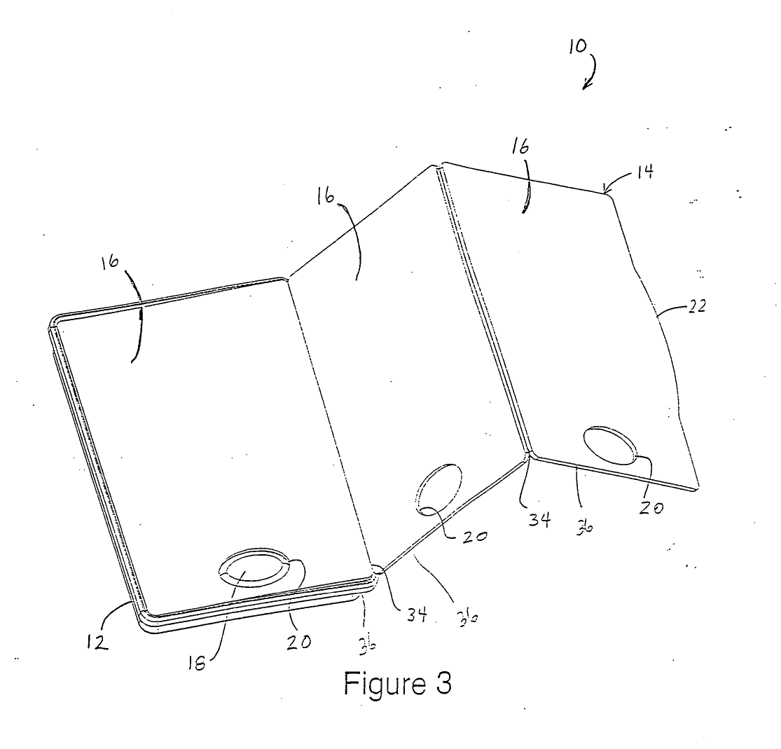

Referring to FIG. 3, the talking card or pamphlet device 10 is shown with the support member 14 unfolded into an extended position. In the present embodiment, the support member 14 comprises three panels each identified by numeral 36 joined to one another at corresponding hinge portions 34. The panels 36 are configured to fold onto one another, and include printed portions 16 for providing a surface to support printed information including graphic displays, which may be relevant to the article of manufacture including basic medically relevant information for medical products. The consumer may move or expand each panel 36 relative to one another to view and read the information contained in related printed portions 16.

Each of the apertures 20 of the panels 36 are positioned to be aligned with one another (see FIG. 1) through which the consumer can access the activation button 18 with the support member 14 in the fully folded position. In this manner the consumer may choose to activate the device 10 without moving or viewing the support member 14. During operation and use, the consumer may read the information printed on the printed portion 16 of the support member 14. With the support member 14 moved into the extended position, the consumer may view more of the area provided by the panels 36. To initiate the audio play back operation, the consumer activates the device 10 through the activation button 18. The audio communication relating to the information contained in the printed portion 16 is thereby conveyed to the consumer thus providing coordinated comprehensive information to the consumer about the article of manufacture including basic medically relevant information for medical products. The audio playback operation is outputted through the speaker device 24 as will be further described hereinafter.

As described above, the printed information and the stored information for creating the audio communication may communicate to the consumer any information concerning an article of manufacture such as a medical product, including, but not limited to, drug information, administration instructions and dosing, symptoms and conditions to be treated, warnings, active ingredients, and basic medically relevant information corresponding to the medical product as defined herein.

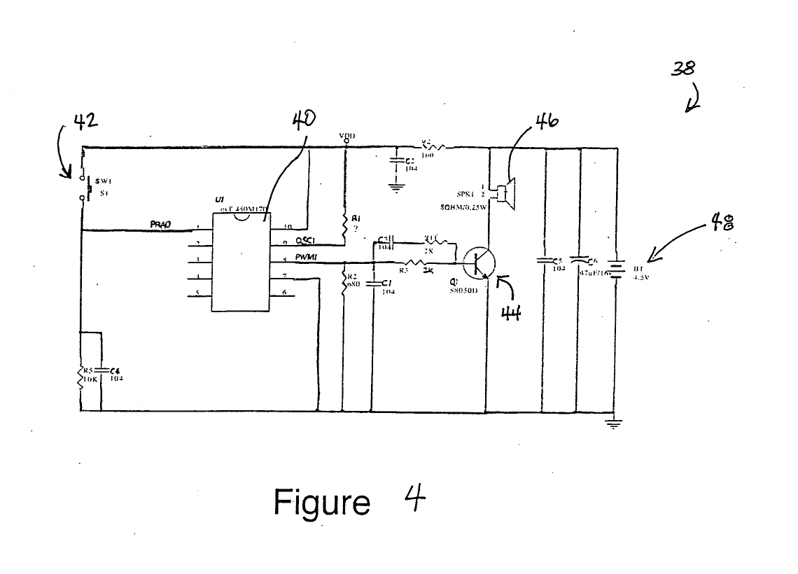

Referring to FIG. 4, the talking card or pamphlet device 10 includes a circuit element 38 having principally a central processor 40, a switch member 42 connected to the input of central processor 40, a signal conditioner 44 connected to the output of the central processor 40, a speaker 46 connected to the output of the signal conditioner 44, and a power source 48 supplying electrical power to the circuit element 38 via the switch member 42. The circuit element 38 is illustrated for the device 10 having a single activation button 18. The switch member 42 is operatively associated with the activation button 18.

The central processor 40 is programmed with the audio information for storage and output, typically corresponding to the information contained in the printed portion of the support member 14. The central processor 40 is activated through the switch member 42, upon depressing the activation button 18 of the talking card or pamphlet device 10 during operation. Once the central processor 40 is energized by the power source 46, an electrical audio signal is outputted to the signal conditioner 44.

The signal conditioner 44 operates to process and amplify the audio signal into a form suitable for driving the speaker 46. The speaker 46 operates as an electro-acoustic transducer that converts electrical signals into sounds for creating the audio communication that is loud enough to be heard at a distance. Accordingly, any message or information can be stored in the central processor 40 for subsequent playback as an audio communication for the consumer.

It will be understood that the device 10 of the present invention may be embodied in the form of an integrally constructed smart card. Using current technology, integrated circuits and peripheral devices can be miniaturized to fit into card size dimensions to yield an integral construction. The device 10 in the form of a smart card may include an integrated circuit using card chip technology for storing electronic information, and a corresponding audio output unit for playing the electronically stored information as an audio communication to the consumer. Such smart cards are readily fabricated with integrated circuitry embedded into a flat, plastic body using current technology. Such integrated circuits can be programmed to store product information for subsequent playback.

The talking card or pamphlet device 10 may be constructed as a single component described above. Alternatively, the talking card or pamphlet device may be constructed in the form of two or more connectable components. In this embodiment, one component may comprise the support member 14 with the printed portion 16, and the central processor 40 storing the information for forming the audio communication corresponding to the printed portion 16, and the other component may comprise the remaining portion of the circuit element 38 such as the switch member 42, the signal conditioner 44, the speaker 46 and the power source 48. The central processor 40 can be electrically coupled to the remaining portion of the circuit element 38 and operated in the manner described above. The first component may be interchanged or substituted with another similar first component that may contain different information on printed portion 16 of the support member 14 and in the corresponding central processor 40.

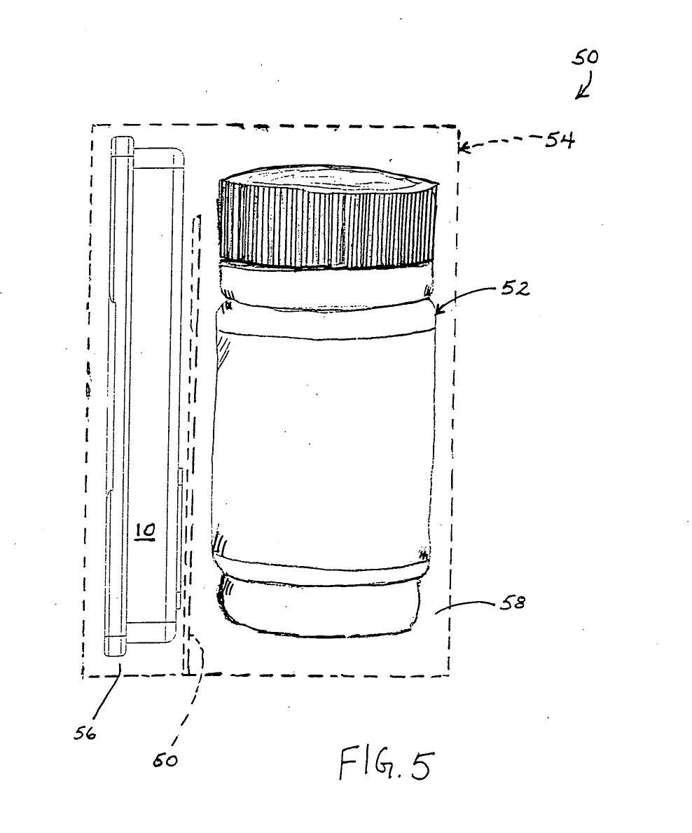

Referring to FIG. 5, an example of a package 50 for distribution as a unit is shown in one embodiment of the present invention. The package 50 comprises the talking card device 10 enclosed in combination with an article of manufacture in the form of a pill container 52 within a box 54. The talking card device 10 as a packaging insert is located within a first compartment 56 of the box 54, and the pill container 52 is located within a second compartment 58 separated from the first compartment 56 by a partition 60.

In another embodiment of the present invention, there is provided a method for enhancing compliance in the proper use of an article of manufacture, wherein the method comprises identifying the article of manufacture for distribution to the user; furnishing to the user a talking card device of the present invention, containing information related to the article of manufacture and pertinent to promoting compliance in the proper use of the article of manufacture; and conveying to the user from the talking card device the information through audio and visual forms of communication.

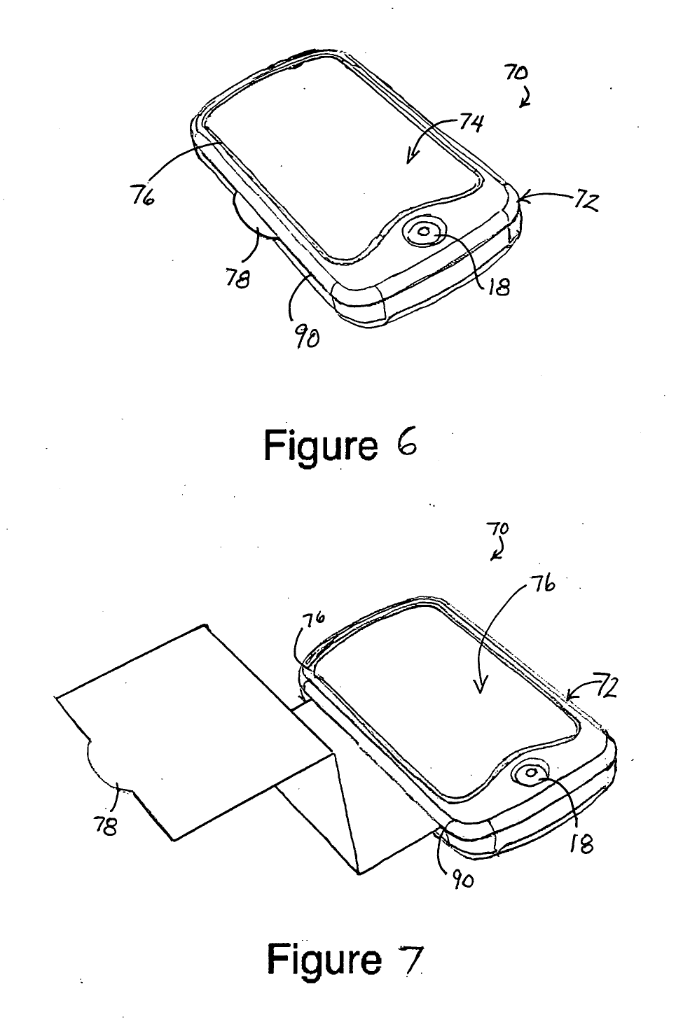

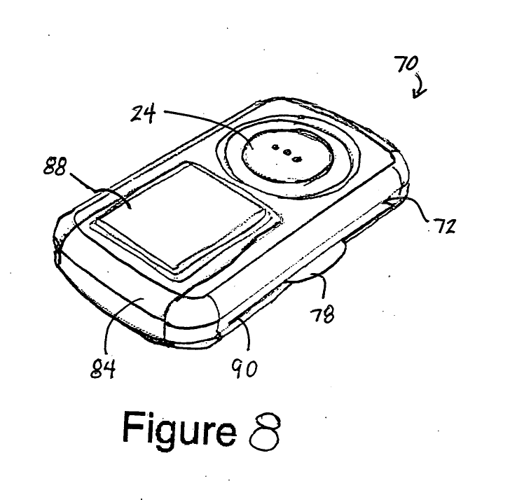

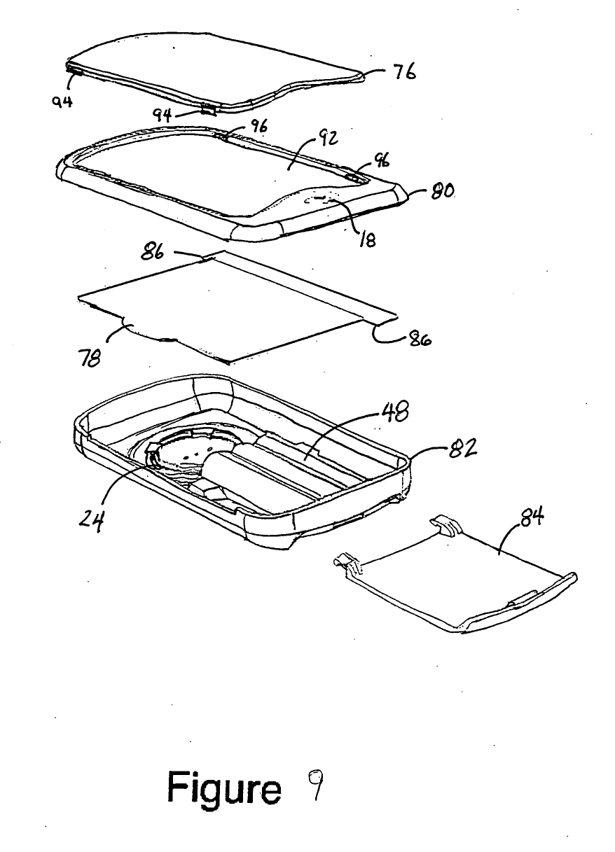

Referring to FIGS. 6 and 7, a talking card or pamphlet device 70 is shown in a second embodiment of the present invention. The present talking card device 70 is closely related in terms of features to the talking card device 10 described above. The talking card device 70 comprises a housing 72, a display area 74 enclosed by a see-through cover 76, and a support member 78 in the form of a pull-out card. The housing 72 accommodates all the components including, the activation button 18, circuit element 38, the speaker device 24, and power source 48 as described above.

The support member 78 can be pulled into an extended position from an opening 90 of the housing 72 for display and viewing, and then returned back into the housing 72 for storage. The display area 74 comprises a recess 92 (see FIG. 9) for receiving and accommodating a card such as, for example, a business card. The cover 76 retains the card in the recess 92 for display to the user.

Referring to FIG. 8, the housing 72 further includes an access cover 84 for the power source 48. The talking card device 70 may further include a fastening means 88 for fastening the device 70 to a surface. The fastening means The fastening means 88 may be selected from any suitable fastening device including, but not limited to, magnets, adhesive products, clips, elastic bands, pin, hook and loop strips, and the like. The fastening means 88 allow the user to place the device 70 at a suitable visible location that is easy to find and see for future reference.

Referring to FIG. 9, the housing 72 of talking card device 70 is comprised of an upper portion 80 and a lower portion 82. The see-through cover 76 is attached to the upper portion 80 of the housing 72, wherein a series of tabs 94 extending along the edge thereof engages corresponding slots 96 located along the edge of the recess 92. The upper portion 80 further comprises the circuit element 38 in connection to the activation button 18. The support member 78 is positioned inside the opening 90 formed between the upper and lower portions 80 and 82, and includes a pair of stop tabs 86 to prevent it from being removed from the opening 90. The lower portion 82 of the housing 72 is adapted to accommodate the power source 48 and the speaker device 24 along with the electrical wirings necessary to connect with the circuit element 38. The access cover 84 securely retains the power source 48 in place within the housing 72.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A talking card device containing information related to an article of manufacture, comprising:
a support member comprising a printed portion containing printed information pertaining to the article of manufacturer viewable by a consumer;
an electronic storage element operatively engaged to the support member, said electronic storage element adapted to store information relating to the article of manufacture in an electronic form;
an audio assembly component electronically connected to the storage element, and configured to receive the electronic form of the information, and to convert the electronic form of the information into an audio communication upon actuation by the consumer; and
means for actuating the audio communication by the consumer.

2. The talking card device of claim 1 wherein the information contained in the printed portion and the audio communication are coordinated to thereby provide comprehensive information about the article of manufacture.

3. The talking card device of claim 2 wherein the comprehensive information is basic medically relevant information.

4. The talking card device of claim 3 wherein the basic medically relevant information is selected from the group consisting of manner of action, proper practice, duration of usage, adverse side effects or risks, consequences of prematurely ceasing usage, and combinations thereof.

5. The talking card device of claim 1 wherein the electronic connection between the storage element and audio assembly is reversible.

6. The talking card device of claim 1 wherein the audio assembly comprises an audio output element for processing the electronic form of the information, and generating the audio communication.

7. The talking card device of claim 6 wherein the audio output element is a speaker.

8. The talking card device of claim 6 wherein the audio assembly further comprises a signal conditioner element located between the storage element and the audio output element for conditioning the electronic form of the information prior to processing by the audio output element.

9. The talking card device of claim 1 further comprising a card receiving area for retaining one or more cards to carry and store.

10. The talking card device of claim 9 wherein the card receiving area is enclosed by a see-through cover.

11. The talking card device of claim 1 wherein the article of manufacture is a medical product.

12. The talking card device of claim 11 wherein the medical product is selected from the group consisting of a medication, a medical device, and combinations thereof.

13. The talking card device of claim 1 wherein the printed portion is a foldable and extendable pull-out.

14. The talking card device of claim 13 wherein the printed portion is returnable into the device.

15. The talking card device of claim 1 is constructed in the form of a smart card.

16. The talking card device of claim 1 further comprising a housing accommodating the audio assembly.

17. The talking card device of claim 1 further comprising fastening means for fastening the device to a surface.

18. The talking card device of claim 17 wherein the fastening means is selected from the group consisting of magnets, adhesive products, clips, elastic bands, pin, hook and loop strips and combinations thereof.

19. The talking card device of claim 1 having a size sufficiently small to insert into a pocket.

20. A packaging insert for an article of manufacture, said packaging insert comprising:
a support member comprising a printed portion containing printed information pertaining to the article of manufacturer viewable by consumer;
an electronic storage element operatively engaged to the support member, said electronic storage element adapted to store information relating to the article of manufacture in an electronic form for subsequent processing into an audio communication by an audio assembly component; and
the audio assembly component electronically connected to the storage element on a permanent or reversible bases, and configured to receive the electronic form of the information, and to convert the electronic form of the information into the audio upon actuation by the consumer.

21. The packaging inert of claim 20 wherein the information contained in the printed portion and the audio communication are coordinated to thereby provide comprehensive information about the article of manufacture.

22. A package comprising an article of manufacture and the talking card device of claim 1.

23. A method of informing a consumer about an article of manufacture, comprising providing the consumer with the talking card device of claim 1.

24. A method for enhancing compliance in the proper use of an article of manufacture, the method comprising:
identifying the article of manufacture for distribution to the user;
furnishing to the user the talking card device of claim 1 containing information related to the article of manufacture and pertinent to promoting compliance in the proper use of the article of manufacture; and
conveying to the user from the talking card device the information through audio and visual forms of communication.
